(19) United States
(12) Patent Application Publication
(10) Pub. No.: US 2009/0173860 A1
(43) Pub. Date: Jul. 9, 2009

(54) Mounting system for flat panel display

(75) Inventor: Steven R. Remy, New York, NY (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Bell'O International Corp., Morganville, NJ (US)

(21) Appl. No.: 12/319,285

(22) Filed: Jan. 5, 2009

Related U.S. Application Data
(60) Provisional application No. 61/010,149, filed on Jan. 4, 2008.

(51) Int. Cl. F16M 13/02

(52) U.S. Cl. 248/278.1

(57) ABSTRACT

A display mounting system includes a mounting structure and a monitor bracket. The mounting structure is attachable to a surface. The monitor bracket includes a tilt mechanism that is securable to a monitor. The tilt mechanism includes a threaded rod and a tilt plate. The tilt plate is operatively connected to the threaded rod such that rotation of the threaded rod changes a tilt angle of the tilt plate and the monitor.

### CROSS-REFERENCE TO RELATED APPLICATIONS

This application claims the benefit of the filing date of U.S. Provisional Application No. 61/010,149, filed Jan. 4, 2008, the disclosure of which is incorporated by reference herein.

### BACKGROUND OF THE INVENTION

The present invention relates to flat panel displays and, more particularly, to mounting systems used for mounting a flat panel display to a wall or other surface.

In recent years, the popularity of flat panel displays and, in particular, the popularity of televisions that use flat panel displays has grown significantly. Such flat panel televisions presently use either a liquid crystal display (LCD) technology or a plasma display technology, though other emerging technologies such as organic light emitting diodes (OLED) and the like are coming into use. The flat panel televisions thus provide a display screen that is much thinner and lighter than that provided in a traditional cathode ray tube or projection television and, as a result, may be mounted directly onto a wall or other vertical surface.

Presently, wall mounts that secure a flat panel television flush against a wall are often used. Alternatively, other existing mounting systems include one or more articulating arms that can be used to adjust the location of a flat panel television secured to the mounting system. As a further alternative, such mounting systems may be configured permit vertical tilting of the associated flat panel television. For such adjustable mounting systems, however, a need exits for an improved arm tensioning and locking device as well as a need for an improved tilt mechanism.

It is therefore desirable to provide a flat panel television mounting system having articulating arms that can be placed under tension or locked into a desired position. It is further desirable to provide a flat panel television mounting system having a mount that can tilt so that the associated flat panel TV can be viewed at a desired angle.

### SUMMARY OF THE INVENTION

According to an aspect of the invention, a display mounting system includes a mounting structure which is attachable to a surface and includes a monitor bracket which includes a tilt mechanism that is securable to a monitor. The tilt mechanism includes a threaded rod, and a tilt plate that is operatively connected to the threaded rod such that rotation of the threaded rod changes a tilt angle of the tilt plate and the monitor.

In accordance with this aspect of the invention, the tilt plate may be operatively connected to the threaded rod in a manner that secures the tilt plate and the monitor at a given tilt angle before the threaded rod is turned. The tilt plate may be operatively connected to the threaded rod in a manner that secures the tilt plate and the monitor at a desired tilt angle after the threaded rod is turned. The tilt plate may be operatively connected to the threaded rod in a manner that allows for the tilt angle of the tilt plate and the monitor to be any angle within a predetermined continuous range of angles. A driving element may be affixed to one end of the threaded rod for causing the threaded rod to turn about its central axis. The driving element may include at least one of a handle, a knob, a grip, a lever, or another hand operable device. The driving element and the threaded rod may be parts of a bolt having a top surface that includes an opening configured to receive a tool. The top surface of the bolt may include a hexagonal opening configured to receive an Allen wrench.

According to another aspect of the invention, a display mounting system includes a mounting structure that is attachable to a surface, a bracket that is securable to a monitor, and a tilt mechanism that is attachable to the bracket and the monitor. The tilt mechanism includes a housing, a threaded rod that extends between a top of the housing and a bottom of the housing and which is retained within the housing in a manner that permits the threaded rod to be rotatable about its central axis, a block that has a threaded opening in which a portion of the threaded rod is disposed and that has a pin which extends along a direction perpendicular to a central axis of the threaded bolt, and a tilt plate that is operatively coupled to the housing and has a slot for retaining the pin. Rotation of the threaded rod causes movement of the block along the central axis of the rod and corresponding movement of the tilt plate and the monitor to a desired position.

In accordance with this aspect of the invention, the housing of the tilt mechanism may be attachable to the mounting structure. The block may include two pins located at opposing ends of the block. The tilt plate may include opposing slots for retaining the two pins. The tilt plate may be operatively coupled to the housing at a pivot point, whereby the rotation of the threaded rod causes the movement of the block along the central axis of the rod and corresponding movement of the tilt plate about the pivot point. The threaded rod may be part of a bolt having a top surface that includes an opening configured to receive a tool. A top surface of the bolt may include a hexagonal opening configured to receive an Allen wrench. A driving element may be affixed to one end of the threaded rod for causing the threaded rod to turn about its central axis. The driving element may include at least one of a handle, a knob, a grip, a lever, or another hand operable device.

According to a further aspect of the invention, a display mounting system includes a mounting structure that is attachable to a surface, a bracket that is securable to a monitor, and a tilt mechanism that is attachable to the mounting structure and to the bracket and monitor. A housing includes a top plate, a bottom plate that faces the top plate, and two opposing side that are plates at least in part disposed between the top plate and the bottom plate. A threaded rod extends between the top plate and the bottom plate and is held by the top and bottom plates in a manner that permits the threaded rod to be rotatable about its central axis. A block has a threaded opening that extends throughout its width and receives a portion of the threaded rod, and has two pins that are located at opposite ends of its length and which extend along a direction perpendicular to a central axis of the threaded opening. A tilt plate includes two opposing side plates and a mounting plate which is disposed between the two side plates. The side plates of the tilt plate have opposing guide slots for retaining the pins and are operatively coupled to the side plates of the housing at a pivot point that permits the tilt plate to pivot with respect to the housing. Rotation of the threaded rod causes the block to move along the central axis of the rod which causes movement of the pins against the side plates of the tilt plate and corresponding movement of the tilt plate about the pivot point to change a tilt angle of the tilt plate and monitor.

In accordance with this aspect of the invention, at least one of the top plate or the bottom plate of the housing may include a sleeve mounted on its inner surface for receiving an end of the threaded rod. The top plate, the bottom plate, and the side plates of the housing may be joined to form a unitary structure. The housing may include a back plate which is arranged perpendicular to the top, bottom, and side plates of the housing and which is configured to receive and be secured to the mounting structure. The back plate of the housing may be configured to receive and be secured to an articulating arm of the mounting structure. The top plate, the bottom plate, the side plates, and the back plate of the housing may be joined to form a unitary structure. The side plates and the mounting plate of the tilt plate may be joined to form a unitary structure. The side plates of the tilt plate may be coupled to the side plates of the housing by a pair of sleeves held in place by another bolt.

The foregoing aspects, features and advantages of the present invention will be further appreciated when considered with reference to the following detailed description and accompanying drawings.

### BRIEF DESCRIPTION OF THE DRAWINGS

FIG. 1 illustrates an example of a known flat panel display mounting system.

FIG. 2 shows a perspective view of a tilt mechanism in accordance with an embodiment of the invention.

FIG. 3 shows an exploded view of the tilt mechanism shown in FIG. 2.

FIG. 4 shows a semi-transparent perspective views of the tilt mechanism shown in FIGS. 2A and 2B.

FIG. 5A shows a perspective view of a flat panel display mounting system in accordance with the invention

FIG. 5B shows a bottom perspective view, FIG. 5C shows a left side view, FIG. 5D shows a top view, FIG. 5E shows a bottom view, FIG. 5F shows a front view, and FIG. 5G shows a rear view of the flat panel display mounting system of FIG. 5A.

FIG. 6 is another perspective view of the flat panel display mounting system of FIG. 5A with the articulating arms bent at a 90 degree angle; and FIG. 6A shows a top view of the flat panel display mounting system of FIG. 6.

FIG. 7 shows a perspective view of the flat panel display mounting system of FIG. 5A when completely folded; and

FIG. 7A shows a top view of the completely folded flat panel display mounting system of FIG. 7.

FIG. 8A shows a perspective view and FIG. 8B shows an exploded view of a locking system used in accordance with the invention with a flat panel display mounting system.

FIG. 9A shows a perspective view of a speaker mounting assembly used in accordance with the invention with a flat panel display mounting system; FIG. 9B shows rear views of the speaker mounting assembly of FIG. 9A; and FIG. 9C shows an exploded front view of the speaker mounting assembly.

### DETAILED DESCRIPTION

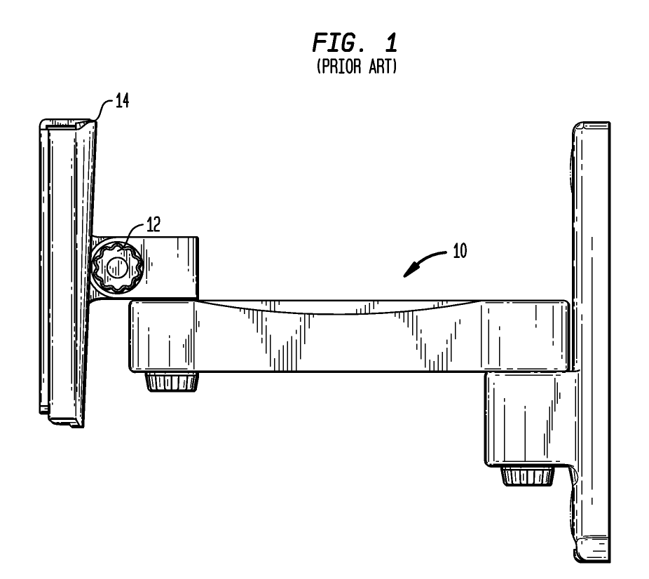

FIG. 1 illustrates an example of a flat panel display mounting system which uses a known knob control to adjust the tilt of a flat panel display. Such a system is depicted, for example, in U.S. Design Pat. No. D580,421 issued Nov. 11, 2008, the disclosure of which is incorporated by reference herein.

The wall mount system 10 includes a knob 12 that is used to control the tilt of a flat panel display held by a bracket 14. To adjust the tilt of the flat panel display, the knob 12 is loosened with one hand of a user while the user's other hand grips the flat panel display and/or bracket and adjusts the tilt of the display and/or bracket to a desired tilt angle. Once the desired tilt angle is attained, the knob 12 is tightened to hold the flat panel display in place.

Display mount systems that use such a known knob control to adjust the tilt angle are best suited for use with smaller, lighter flat panel displays for which one person can carry out the tilt angle adjustment. For larger and/or heavier flat panel displays, however, using such knob controls to adjust the tilt angle is not desirable. The flat panel display is usually too heavy or cumbersome to be held by the same person that loosens and tightens the knob, and as a result, two or more people may be required to adjust the tilt of the flat panel display. Moreover, such heavier displays may be difficult to hold in place for sufficient time to tighten the knob, resulting in the display not being set at the desired angle. Additionally, the weight of the flat panel display may cause the knob to loosen over time and/or cause the tilt angle to drift downward.

Alternatively, the knob control may be used in combination with a locking mechanism that allows the display to be secured at one of a number of discrete tilt angles. Such a system is nonetheless not desirable because more than one person is likely to be needed to carry out the adjustment and a continuous range of tilt angles is not available.

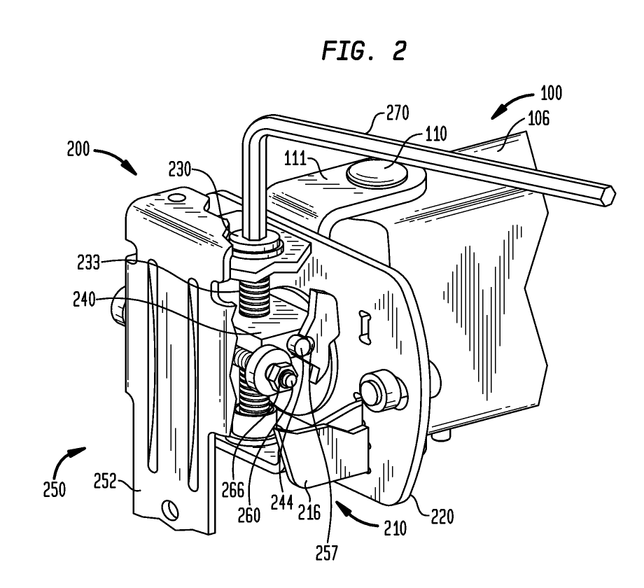

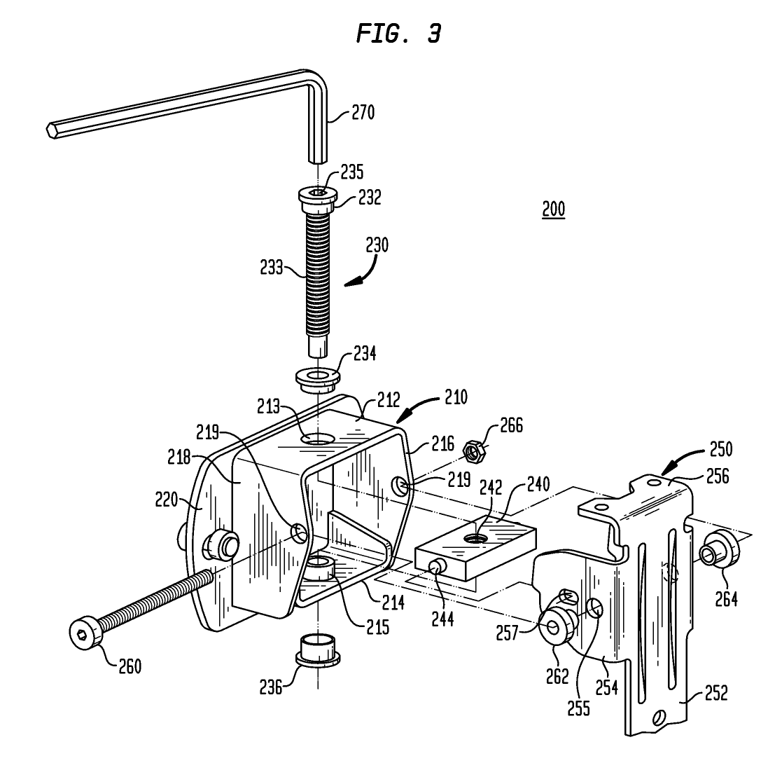

FIG. 2 shows a perspective view of a tilt mechanism 200 in accordance with the invention. The tilt mechanism 200 includes a housing 210 having a back plate 220 that is connectable through screws or other means to an arm of a flat panel display mounting system. The housing 210 also supports a bolt 230 or other threaded element which is operatively connected to a mounting plate 250 in a manner such that turning the bolt 230 changes a tilt angle of the tilt plate 250. The tilt plate 250 is typically part of a monitor bracket (not shown in FIG. 2) to which a flat panel display may be secured so that adjusting the tilt angle of the tilt plate also changes the tilt angle of the flat panel display.

FIG. 3 depicts an exploded view of the tilt mechanism 200 of FIG. 2 and shows the inner workings thereof. The housing 210 includes a top plate 212, a bottom plate 214, and side plates 216 and 218, as well as the back plate 220. The bolt 230 includes a threaded portion 233 and a head portion 232. An opening 235 in the top of the head portion 232 is preferably hexagonally-shaped to permit insertion of a corresponding-sized Allen wrench 270. Alternatively, the opening 235 may be configured to allow the bolt to be turned by another tool, such as a flathead screwdriver, a Phillips screwdriver, a torx key, or the like. As a further alternative, a different driving element is provided in place of the head portion 232 and may include one or more of a handle, a knob, a grip, a lever, or other hand operable device.

An opening 213 in the top plate 212 of the housing 210 receives a sleeve 234, and an opening in the sleeve 234 receives the bolt 230. An opening 215 in the bottom plate 214 of the housing 210 similarly receives a sleeve 235, and an opening in the sleeve 235 also receives the bolt 230. Thus, the sleeves 234 and 235 enable the bolt 230 to turn about its axis.

A block 240 includes a threaded hole 242 that receives part of the threaded portion 233 of the bolt 230. By turning the bolt 230 while the bolt and the block are both mounted in the housing 210, the block is caused to move along the central axis of the bolt 230. Respective pins 244 are located at each end of the block and extend outward from the block 240. Though a block having a rectangular shape is shown, other shaped blocks having the opening 242 and pins 244 may be used.

The tilt plate 250 includes a mounting plate 252, opposing side plates 254, and a top plate 256. The mounting plate 252 is configured to be bolted or otherwise attached to a monitor bracket. The side plates 254 are located at each side of the mounting plate and each includes an opening 255 which is situated to correspond to openings 219 of the side plates 218 of the housing 210 and to receive one of sleeves 262 and 264. A bolt 260 is inserted through the opening 219 of the housing and the sleeves 262 and 264 to permit the tilt plate 250 to pivot about the bolt 260. The bolt and sleeves are held in place using a nut 266.

Each of the side plates 254 of the tilt plate 250 also includes a respective slot 257 which receives the one of the pins 244 of the block 240. The positioning of the pins 244 within the slots 257 of the tilt plate 250 allow for the adjustment of the tilt angle of the tilt plate by turning the bolt 230. Namely, the rotation of the bolt 230 causes the block 240 to move along the axis of the bolt which, in turn, causes the pins 244 at each side of the block to push against the side plates 254 of the tilt plate and so that the tilt plate pivots about the bolt 260 and thereby change the tilt angle of the mounting plate 252 of the tilt plate 250.

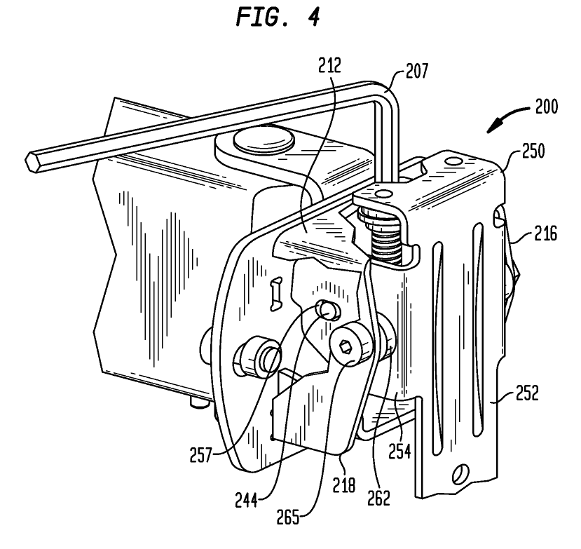

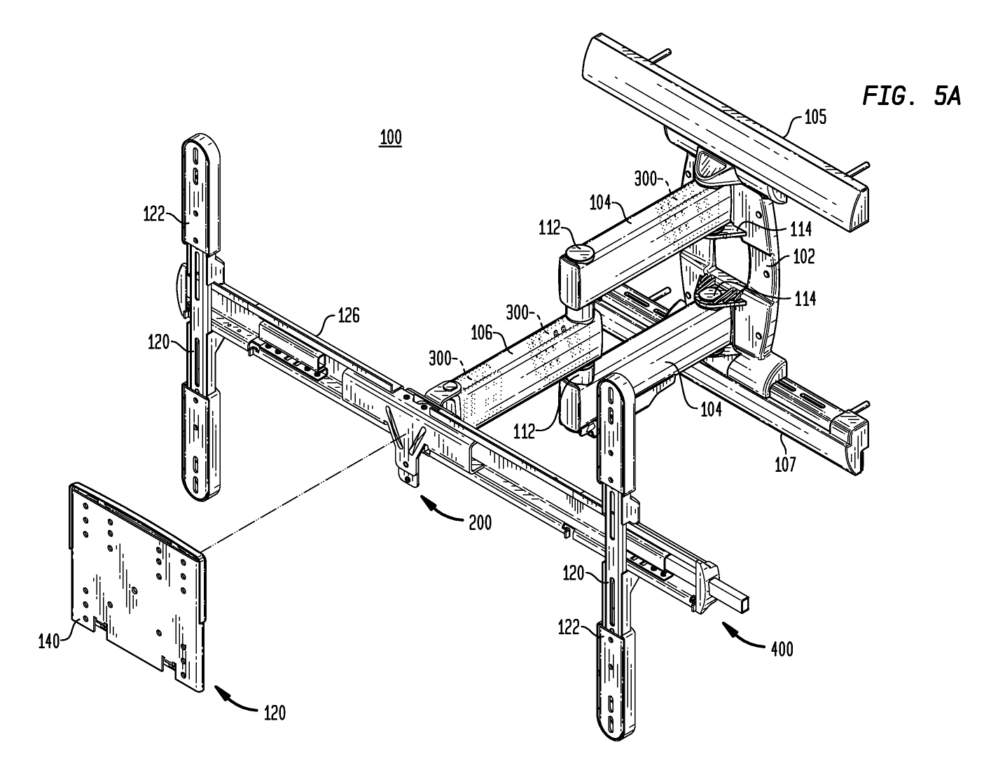

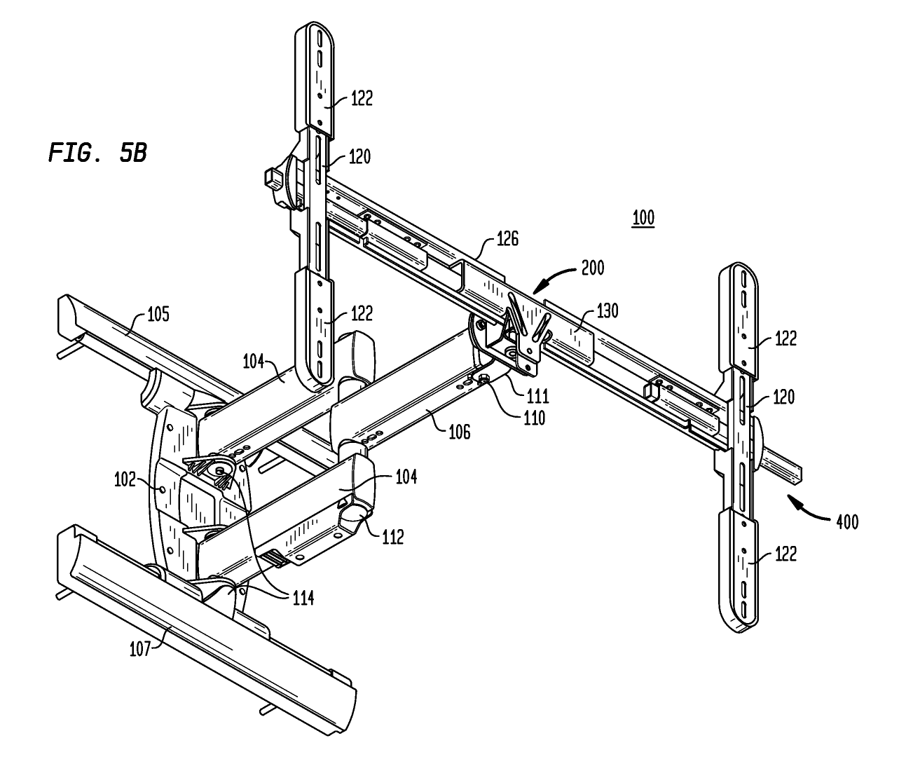

FIG. 4 is a perspective view of the tilt mechanism 200 in which the tilt mechanism 200 is shown. In FIG. 4, the top plate 212 and the side plates 216 and 218 of the housing 200 are shown with the bolt 230 inserted into the housing 210 with the head 232 thereof seated in the sleeve 234 and the threaded portion 233 thereof located within the housing 210. Also, the pin 244 is shown disposed within the slot 257 of the side plate 254 of the tilt mechanism 250. Additionally, the side plates 254 are held in place by the head of the bolt 260 and sleeve 262.

the threaded part 233 of the bolt 230 has in the fully assembled tilt mechanism 200, a portion seated in the threaded opening of the block 240. The bolt 230 is also seated in the sleeves 234 and 236 which hold the bolt in place and prevent the bolt from turning while not being driven.

The use of a bolt or other threaded element to drive the movement of the tilt plate allows for the tilt angle of the tilt plate to be adjusted to any angle within a continuous range of angles. Moreover, the sleeves 234 and 236 (which retain the threaded bolt 230 or other threaded element) and the sleeves 262 and 264 (disposed between the side plates of the housing and the side plates of the tilt plate) not only allow for the bolt or other threaded element to move when turned but also provide friction that holds the bolt or other threaded element and tilt plate in position before or after the bolt or other threaded element is turned so that the tilt angle of the tilt plate does not change after being adjusted. Additionally, when a threaded bolt that can only be driven using an Allen wrench or other removable tool is provided, the tilt angle cannot be changed once the tool is removed and thus prevents the tilt angle from being changed by an unauthorized person. Further, the tilt mechanism also enables adjustment of the tilt angle of larger and/or heavier flat panel displays by one person of ordinary strength.

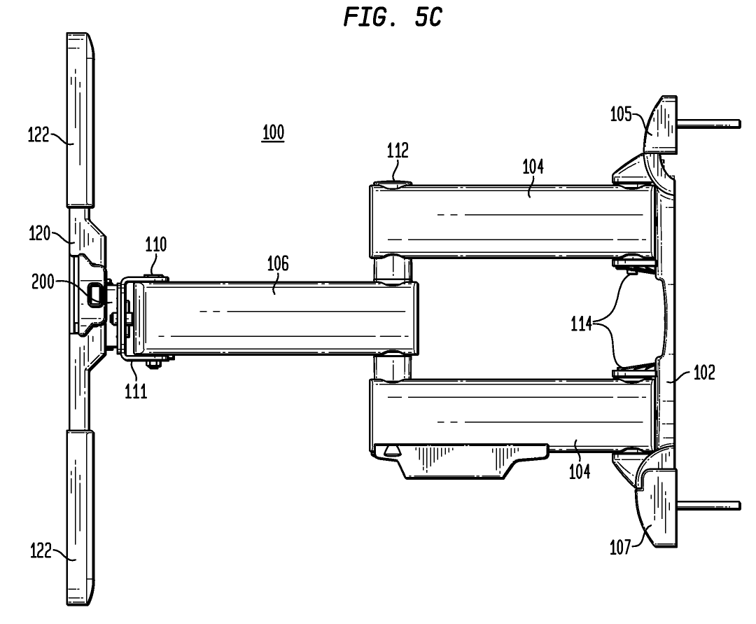

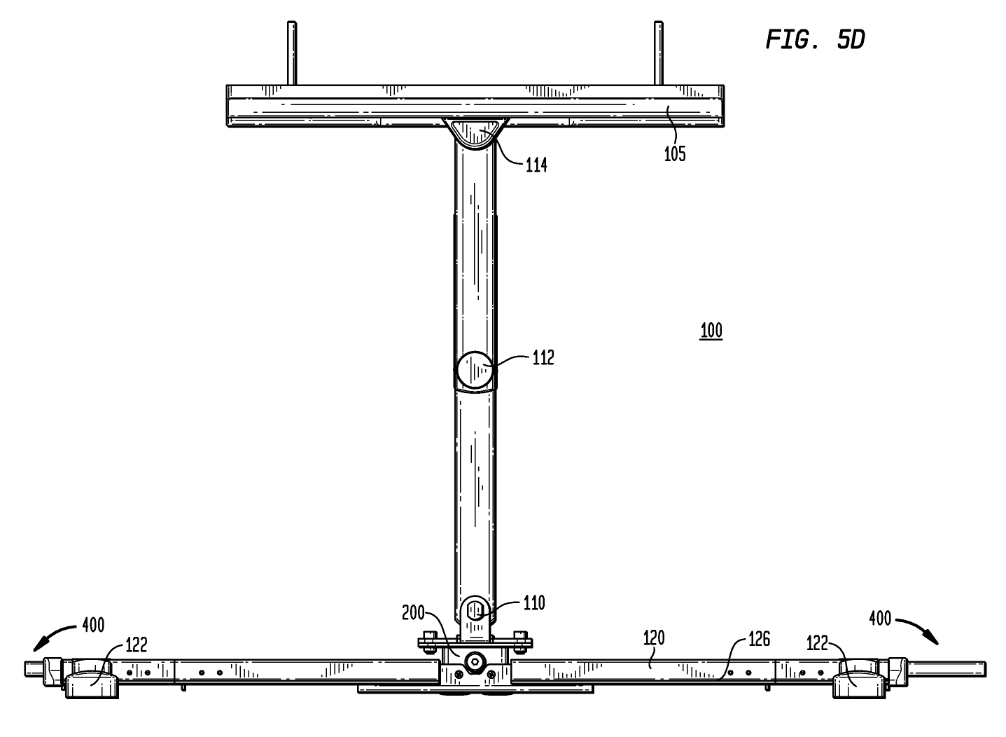

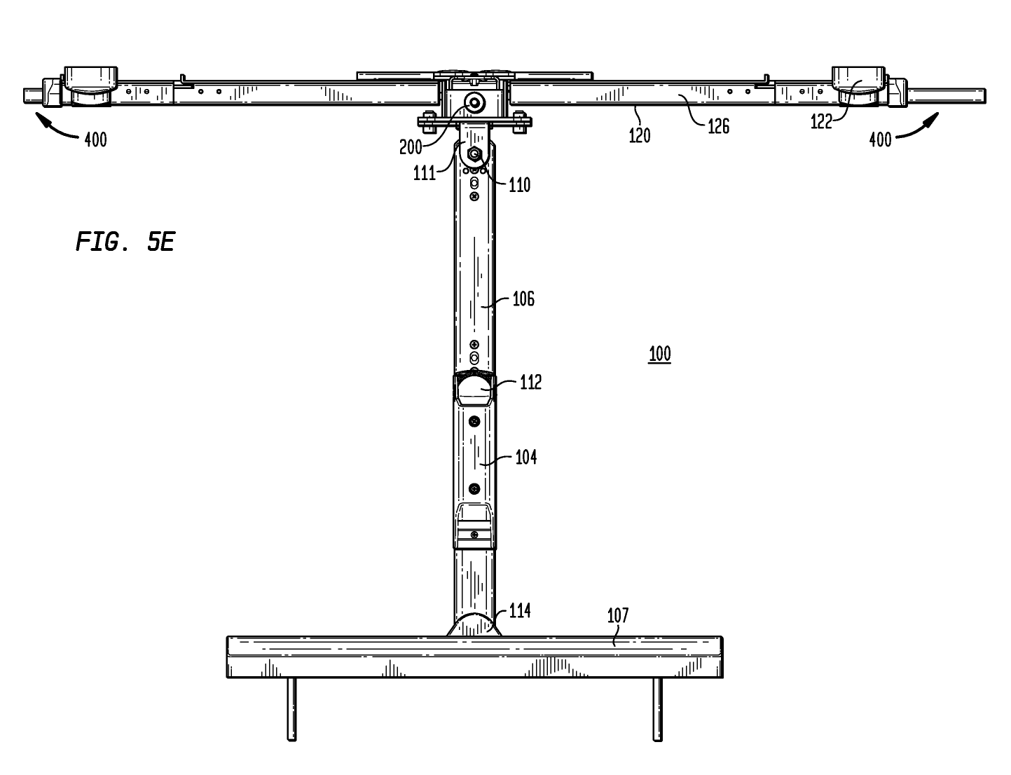

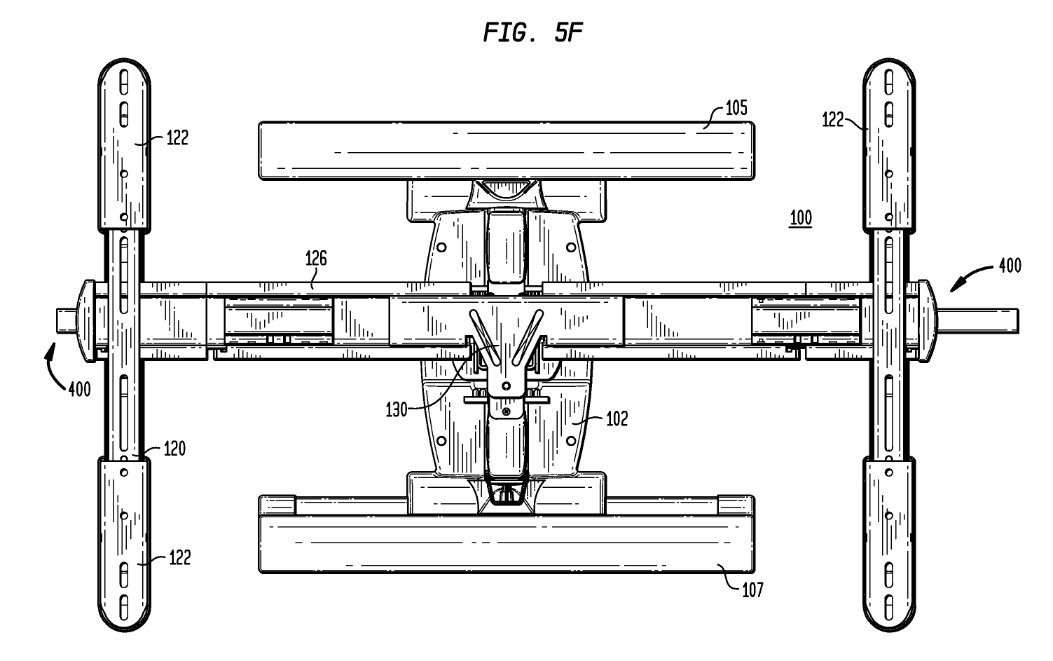

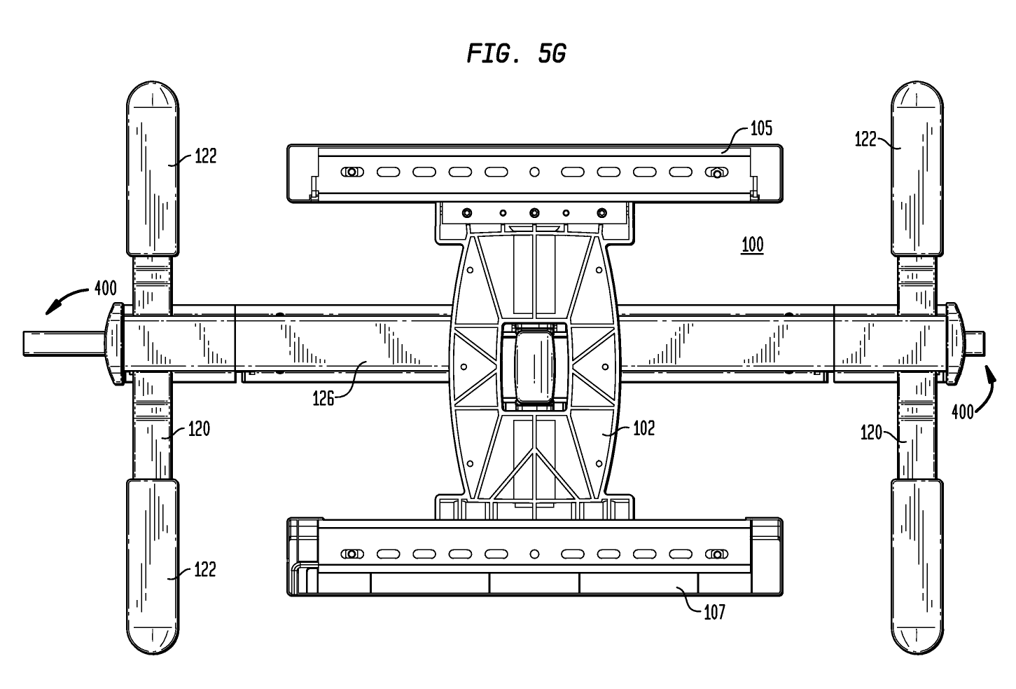

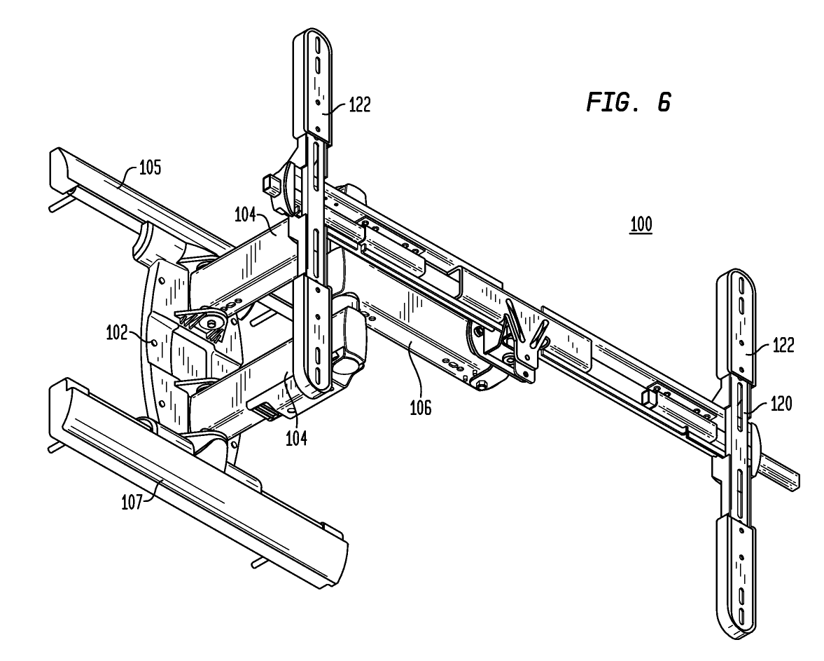

FIG. 5A shows a perspective view of a flat panel display mounting system 100 in accordance with an embodiment of the invention. The mounting system 100 includes the tilt mechanism 200 shown in FIGS. 2-4. However, the tilt mechanism 200 is also suitable for incorporation into other designs for flat panel display mounting systems.

The flat panel display mounting system 100 includes a top element 105 and a bottom element 107 for securing the flat panel display mounting system to a wall or other surface. A pivot plate 102 is provided between the top element 105 and the bottom element 107 and is configured to slide along tracks formed in the top and bottom elements. A pair of extension arms 104 are each pivotally connected at one end to the pivot plate 102 about respective pivot points 114. Another extension arm 106 is pivotally connected at one end to the other end of the two arms 104 about pivot point 112. Referring back to FIG. 2, another end of the arm 106 includes a further pivotal connection 110 to a bracket 111 which is secured to the back plate 220 of the housing 210 of the tilt mechanism 200.

Referring again to FIG. 5A, a monitor bracket 120 includes the tilt mechanism 200, an arm 126 which is attached to the tilt plate 250 of the tilt mechanism 200, and arms 122 which are attached to the arm 126 and to which a larger and/or heavier flat panel display may be secured. Alternatively, the monitor bracket 120 includes the tilt mechanism 200 and a mounting plate 140 to which a smaller and/or lighter flat panel display may be secured. Typically, the monitor bracket includes either the mounting plate 140 or the arms 126,122, though both the mounting plate and the arms are shown in FIG. 5A for illustrative purposes.

Locking mechanisms 300 are provided within articulating arms 104 to lock the arms in place about pivots 114. Additional locking mechanisms 300 are included at each end of the articulating arm 106 to lock the arm in place about pivots 112 and 110, respectively. A speaker mounting assembly 400 is provided at each end of the mounting bracket 120.

FIGS. 5B-5G show additional views of the flat panel display mounting system of FIG. 5A which are also shown in U.S. Application No. 29/294,336, filed Jan. 4, 2008, now U.S. Design Pat. No. D581,915, issued Dec. 2, 2008, the disclosure of which is incorporated by reference herein. FIGS. 5A and 5B show top and bottom perspective views, respectively, of the flat panel display mounting system 100 of FIG. 5A. Further, FIG. 5C shows a side view of the flat panel display mounting system 100. Additionally, FIG. 5D shows a top view and FIG. 5E shows a bottom view of the flat panel display mounting system 100. Further, FIG. 5F shows a front view and FIG. 5G shows a rear view of the flat panel display mounting system 100.

FIG. 5A also shows a perspective view of the flat panel display mounting system 100 with the arms 104,106 are fully extended with respect to the pivot plate 102.

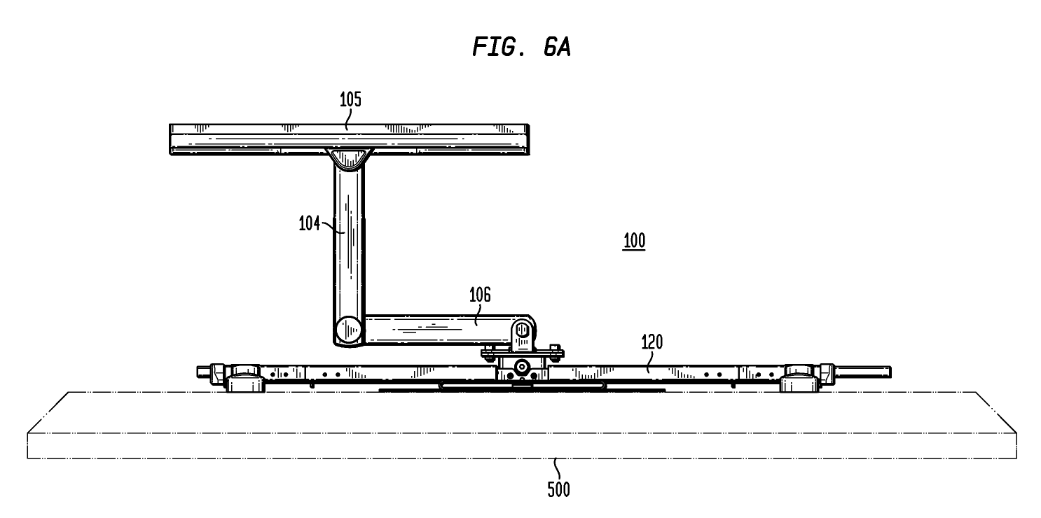

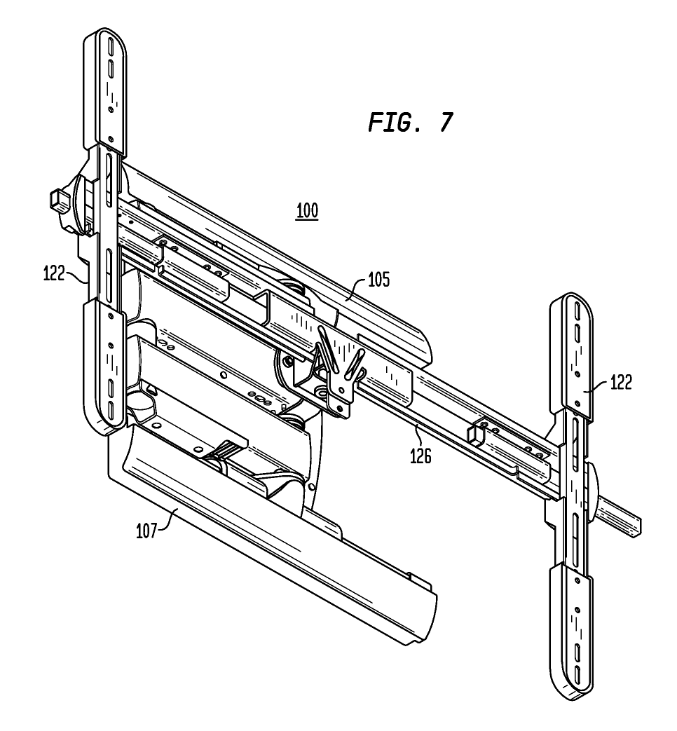

FIG. 6 shows a perspective view of the flat panel display mounting system 100 in which the arm 106 is disposed at a substantially 90 degree angle with respect to the arms 104 and is located flush behind mounting bracket 120.

FIG. 6A shows a top view of the flat panel display mounting system 100 and more clearly show the position of the articulating arm 106 with respect to the articulating arms 104 and the mounting brackets 120. FIG. 6A also shows, in phantom, a flat panel display 500 secured to the mounting bracket 120.

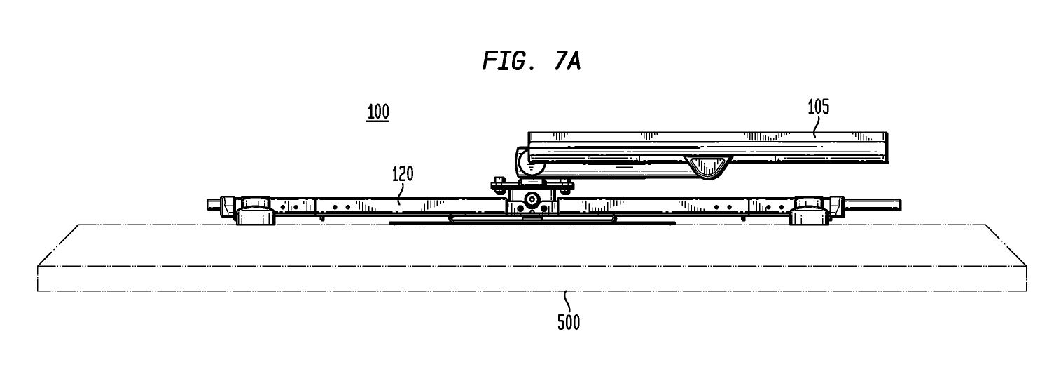

FIG. 7 shows a perspective view of the flat panel display mounting system 100 when completely folded so that the mounting bracket 120 is almost flush with the wall. FIG. 7A shows a top view of the completely folded flat panel display mounting system 100. FIG. 7A also shows, in phantom, the flat panel display 500 secured to the mounting bracket 120.

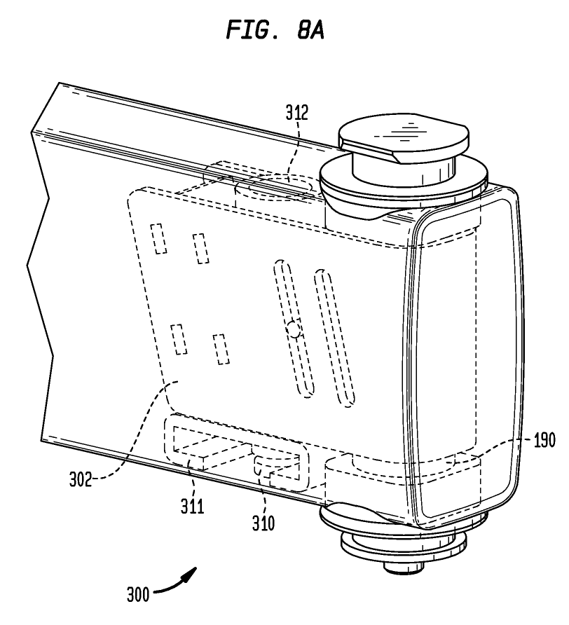

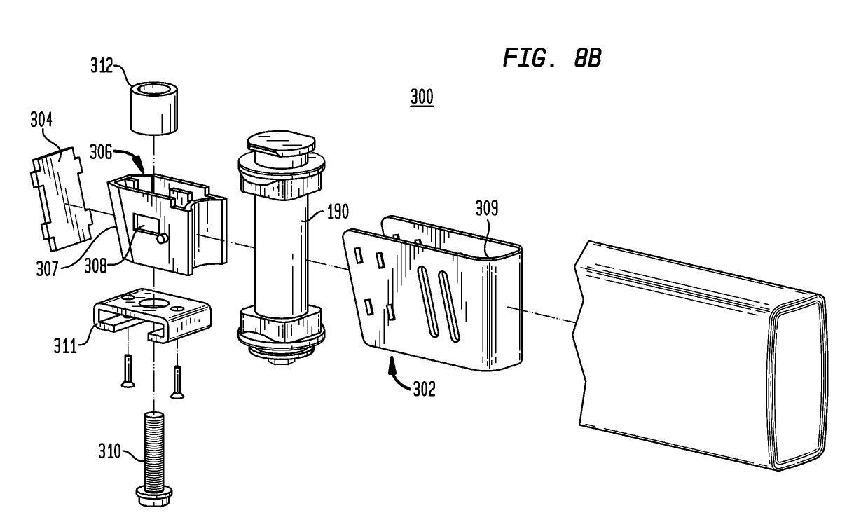

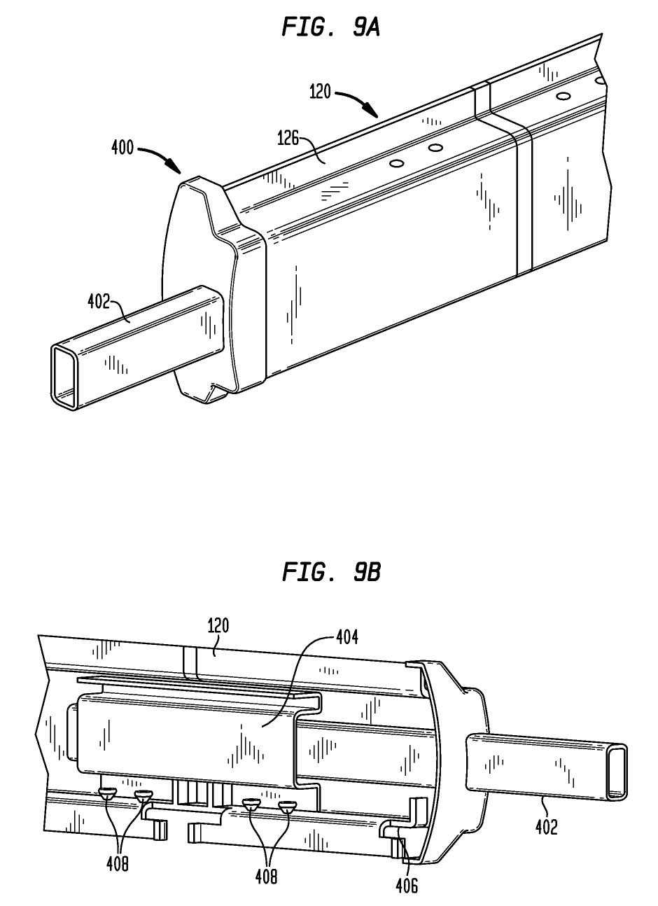

FIGS. 8A and 8B depict a shaft locking system 300 in accordance with the invention. Though the locking system 300 is also shown in FIGS. 5-7 in use within with the flat panel display mounting system 100, the locking system 300 is not limited to such use and may alternatively be implemented within other flat panel display mounting system designs.

FIG. 8A shows a perspective view of the locking system 300 depicted within a semi-transparent view of an extending arm, such as arms 104 and/or 106. The locking system 300 is used to either secure a movable arm to a fixed shaft or to secure an arm to a rotatable shaft. More specifically, an outer housing 302 of the locking system 300 is shown and includes a sliding surface 304.

FIG. 8B shows an exploded view of the locking system 300 in relation to the shaft 190 of the extending arm. An inner housing 306 is disposed within the outer housing 302 and includes a sliding surface 307 which abuts the sliding surface 304 of the outer housing 302.

A block 308 is disposed within the inner housing 306 and includes a threaded opening (not shown). A threaded rod 310, which has a portion that is received within the threaded opening of the block 308, can be turned about its axis of rotation to drive the block up or down along the axis of the threaded rod and thereby similarly drive the inner housing 306. The inner housing 306 includes a limiting collar 312 that acts a stop and limits the movement of the inner housing 306. The threaded rod 310 may be part of a bolt that can be turned using, for example, an Allen wrench, a flathead screwdriver, a Phillips screwdriver, a torx key, or other tool. Alternatively, a different driving element may be provided to turn the threaded rod 310 and may include one or more of a handle, a knob, a grip, a lever, or other hand operable device.

As the inner housing 306 is driven by the rotation of the threaded rod 310, the sliding surface 307 of the inner housing 306 moves against the sliding surface 304 of the outer housing 302 and causes the outer housing 302 to move toward or away from a shaft 190. To lock the arm against the shaft and/or lock the shaft against the arm, the threaded rod 310 is turned in a manner in which the movement of the sliding surface 307 of the inner housing 306 against the sliding surface 304 of the outer housing 302 causes the outer housing 302 to move away from the shaft so that an end portion 309 of the outer housing 302 abuts the shaft. The outer housing 302 is driven in this manner until the shaft and/or the arm are secured.

Additionally, a bracket portion 311 of the outer housing 302, which holds an end of the threaded rod 310, may include a slot 320 that also allows the inner housing 306 to move laterally when the sliding surface 307 of the inner housing 306 is caused to move against the sliding surface 304 of the outer housing 302 by the turning of the threaded rod 310. The lateral movement of the inner housing 306, when driven towards the shaft 190, causes an end portion 307 of the inner housing 306 to abut and press against the cylinder 190 and thus also holds the arm and/or shaft in place and prevented from turning.

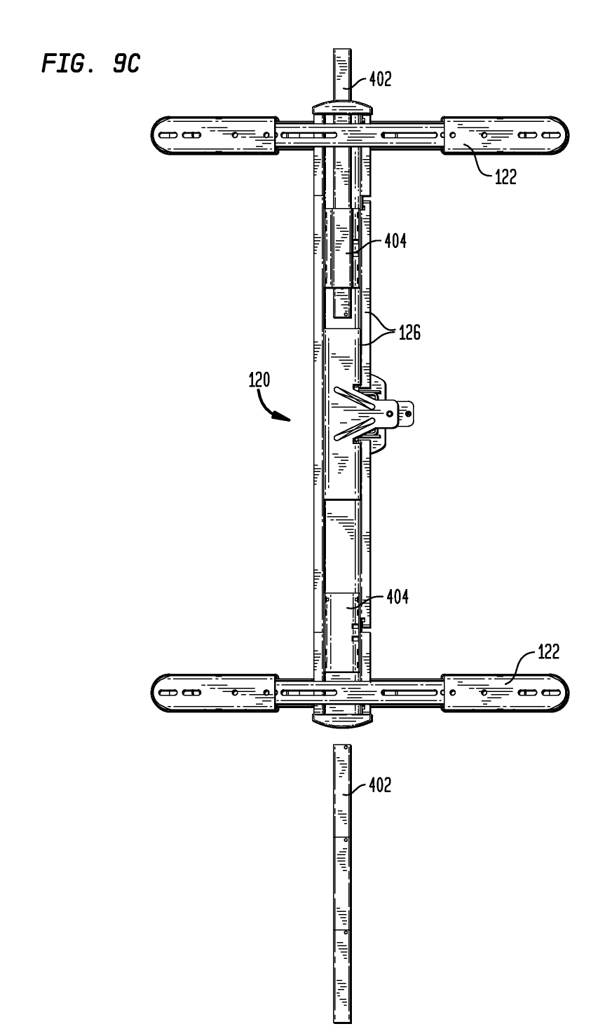

FIGS. 9A-9C illustrate a speaker mounting assembly 400 in accordance with another aspect of the invention. Though the speaker mounting assembly 400 is shown previously in combination with the flat panel display mounting system 100, the speaker mounting assembly 400 is also compatible with other flat panel display mounting system designs.

As FIG. 9A shows, an arm 402 slides in and out of each end of the arm 126 of the mounting bracket 120 of the flat panel display mounting system. The arm 402 is suitable for receiving a speaker adapter (not shown) which, for example, a speaker may hook onto. FIG. 9B shows a rear view of the arm 126 of the mounting bracket 120.

As FIG. 9B shows, the arm 402 slides along a bracket 404 which is attached to the arm 126 of the mounting bracket 120. The arm 402 may be secured to the bracket 404 using, for example, one or more set screws that extend through corresponding openings (not shown) at the bottom of the bracket 404. Alternatively, the arm 402 may be secured using one or more set screws through corresponding openings (not shown) at the back of the bracket 404. FIG. 9C shows an exploded view in which the arm 402 is removed from the mounting bracket 120.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A display mounting system, comprising:
a mounting structure that is attachable to a surface; and
a monitor bracket including a tilt mechanism that is securable to a monitor, the tilt mechanism including:
a threaded rod, and
a tilt plate operatively connected to the threaded rod such that rotation of the threaded rod changes a tilt angle of the tilt plate and the monitor.

2. A display mounting system according to claim 1, wherein the tilt plate is operatively connected to the threaded rod in a manner that secures the tilt plate and the monitor at a given tilt angle before the threaded rod is turned.

3. A display mounting system according to claim 1, wherein the tilt plate is operatively connected to the threaded rod in a manner that secures the tilt plate and the monitor at a desired tilt angle after the threaded rod is turned.

4. A display mounting system according to claim 1, wherein the tilt plate is operatively connected to the threaded rod in a manner that allows for the tilt angle of the tilt plate and the monitor to be any angle within a predetermined continuous range of angles.

5. A display mounting system according to claim 1, further comprising: a driving element affixed to one end of the threaded rod for causing the threaded rod to turn about its central axis.

6. A display mounting system according to claim 5, wherein the driving element includes at least one of a handle, a knob, a grip, a lever, or another hand operable device.

7. A display mounting system according to claim 5, wherein the driving element and the threaded rod are parts of a bolt having a top surface that includes an opening configured to receive a tool.

8. A display mounting system according to claim 7, wherein the top surface of the bolt includes a hexagonal opening configured to receive an Allen wrench.

9. A display mounting system, comprising:
a mounting structure that is attachable to a surface;
a bracket that is securable to a monitor; and
a tilt mechanism attachable to the bracket and the monitor, and including:
a housing,
a threaded rod extending between a top of the housing and a bottom of the housing and being retained within the housing in a manner that permits the threaded rod to be rotatable about its central axis,
a block having a threaded opening in which a portion of the threaded rod is disposed, the block having a pin extending along a direction perpendicular to a central axis of the threaded bolt, and
a tilt plate operatively coupled to the housing and having a slot for retaining the pin,
whereby rotation of the threaded rod causes movement of the block along the central axis of the rod and corresponding movement of the tilt plate and the monitor to a desired position.

10. A display mounting system according to claim 9, wherein the housing of the tilt mechanism is attachable to the mounting structure.

11. A display mounting system according to claim 9, wherein the block includes two pins located at opposing ends of the block.

12. A display mounting system according to claim 11, wherein the tilt plate includes opposing slots for retaining the two pins.

13. A display mounting system according to claim 11, wherein the tilt plate is operatively coupled to the housing at a pivot point, whereby the rotation of the threaded rod causes the movement of the block along the central axis of the rod and corresponding movement of the tilt plate about the pivot point.

14. A display mounting system according to claim 9, wherein the threaded rod is part of a bolt having a top surface that includes an opening configured to receive a tool.

15. A display mounting system according to claim 14, wherein a top surface of the bolt includes a hexagonal opening configured to receive an Allen wrench.

16. A display mounting system according to claim 9, further comprising: a driving element affixed to one end of the threaded rod for causing the threaded rod to turn about its central axis.

17. A display mounting system according to claim 16, wherein the driving element includes at least one of a handle, a knob, a grip, a lever, or another hand operable device.

18. A display mounting system, comprising:
a mounting structure that is attachable to a surface;
a bracket that is securable to a monitor; and
a tilt mechanism attachable to the mounting structure and to the bracket and monitor, and including:
a housing that includes a top plate, a bottom plate that faces the top plate, and two opposing side plates at least in part disposed between the top plate and the bottom plate,
a threaded rod extending between the top plate and the bottom plate and held by the top and bottom plates in a manner that permits the threaded rod to be rotatable about its central axis,
a block having a threaded opening that extends throughout its width and receives a portion of the threaded rod, and having two pins that are located at opposite ends of its length and extend along a direction perpendicular to a central axis of the threaded opening, and
a tilt plate that includes two opposing side plates and a mounting plate disposed between the two side plates, the side plates of the tilt plate having opposing guide slots for retaining the pins and being operatively coupled to the side plates of the housing at a pivot point that permits the tilt plate to pivot with respect to the housing,
whereby rotation of the threaded rod causes the block to move along the central axis of the rod which causes movement of the pins against the side plates of the tilt plate and corresponding movement of the tilt plate about the pivot point to change a tilt angle of the tilt plate and monitor.

19. A display mounting system according to claim 18, wherein at least one of the top plate or the bottom plate of the housing includes a sleeve mounted on its inner surface for receiving an end of the threaded rod.

20. A display mounting system according to claim 18, wherein the top plate, the bottom plate, and the side plates of the housing are joined to form a unitary structure.

21. A display mounting system according to claim 18, wherein the housing includes a back plate arranged perpendicular to the top, bottom, and side plates of the housing and configured to receive and be secured to the mounting structure.

22. A display mounting system according to claim 21, wherein the back plate of the housing is configured to receive and be secured to an articulating arm of the mounting structure.

23. A display mounting system according to claim 21, wherein the top plate, the bottom plate, the side plates, and the back plate of the housing are joined to form a unitary structure.

24. A display mounting system according to claim 18, wherein the side plates and the mounting plate of the tilt plate are joined to form a unitary structure.

25. A display mounting system according to claim 18, wherein the side plates of the tilt plate are coupled to the side plates of the housing by a pair of sleeves held in place by another bolt.
